(19) United States
(12) Patent Application Publication
(10) Pub. No.: US 2006/0022368 A1
(43) Pub. Date: Feb. 2, 2006

(54) Method of fabricating polyurethane foam with micro pores and polishing pad therefrom

(76) Inventors: Kyu-Don Lee, Incheon-si (KR); Yoon-Jong Cha, Incheon-si (KR)

Correspondence Address: JACOBSON HOLMAN PLLC, 400 SEVENTH STREET N.W., SUITE 600, WASHINGTON, DC, 20004, US

(21) Appl. No.: 10/528,159

(22) PCT Filed: Nov. 18, 2003
(86) PCT No.: PCT/KR03/02472

§ 371 Date: Mar. 17, 2005

(30) Foreign Application Priority Data
Nov. 18, 2002 (KR) 10-2002-0071715.

(51) Int. Cl. B29C 44/02; B29C 44/46; B24D 11/00

(52) U.S. Cl. 264/51; 451/526

(57) ABSTRACT

To provide a method of fabricating a polyurethane foam with micro pores, and a polishing pad therefrom, the method including steps of (a) adding a nonionic surfactant into at least one of a first ingredient including an isocyanate group-containing compound and a second ingredient including an active hydrogen group-containing compound, (b) agitating and mixing the mixture of the first ingredient and the second ingredient while adding a non-reactive gas thereto, (c) discharging the mixture out of a container at a predetermined rate, and (d) injecting the discharged mixture into a mold so as to form a mold body into a predetermined shape.

### TECHNICAL FIELD

The present invention relates to a method of fabricating a polyurethane foam with micro pores and a polishing pad therefrom, and more particularly, a method of fabricating a polishing pad used for a planarization process on a semiconductor wafer by chemical mechanical polishing (CMP), and a polishing pad therefrom.

### BACKGROUND ART

With high integration of semiconductor devices in recent years, the fineness and compactness of line patterns thereon are also rapidly increasing. In this view, the exposure technology for transferring patterns on a semiconductor wafer is an important process, but the improvement of the exposure technology alone is not enough to satisfy the recent demand as above. Furthermore, the number of layers formed on the wafer is increasing along with the rapidly-developing high integration trend, and the roughness of the wafer surface is increased, which may cause difficulties in forming very fine line patterns. Thus, there is also a strong demand for improving the planarization technology on the wafer surface.

As described above, the demand for highly-integrated semiconductor devices requires that smaller line patterns and interconnect lines be formed on a smaller space of a wafer, and the flatness tolerance of the semiconductor wafer becomes much smaller. Thus, a polishing pad used for planarizing the surface of a wafer in a CMP apparatus is also expected to have improved functional features.

The CMP apparatus, employed in typical semiconductor fabrication processes, may include a turntable for rotating a polishing pad mounted thereon, a wafer carrier for rotating a wafer mounted on the turntable and transferring the wafer as are progressed, a polishing slurry supplier for supplying polishing slurry from the top of the turntable, and a diamond dresser, etc.

The CMP apparatus operates such that a load is applied to a semiconductor wafer disposed on the top of the polishing pad while rotating the turntable, and polishing slurry is allowed to be supplied to the polishing pad and the semiconductor wafer continuously. Thus, the wafer is polished mechanically and chemically by the friction between the wafer and the polishing pad and the chemical ingredients of the polishing slurry. The slurry, typically used for oxide layers, is a high alkali aqueous solution, for example, which is made by mixing colloidal silica or fumed silica of 10 to 20 vol. % with potassium hydroxide (KOH) or ammonium hydroxide (NH₄OH) to be adjusted to have pH 10 to 12. Herein, the silica particles effect the mechanical polishing and the high alkali aqueous solution effects the chemical polishing.

During the CMP process, the polishing pad is rotated under continuously applied pressure, and herein, the micro pores in the polishing pad may be often clogged by the polishing residues generated from the semiconductor wafer being polished, and in some cases may lose their function of containing the slurry. Thus, the diamond dresser is supposed to condition the surface of the polishing pad to remove the protrusions on the polishing surface of the polishing pad and make the non-uniform polishing surface smooth and even.

The polishing pad herein used for the CMP apparatus can be classified into two types, that is, a porous non-woven fabric type and a foam polyurethane induced type, in which the porous non-woven fabric type is made by impregnating the non-woven fabric with polyurethane, and the foam polyurethane type is made by processing a polyurethane solution by a wet coagulation method. All of them have pores on their surfaces, and function to contain polishing slurry during the polishing process.

In the meantime, a first example of the prior arts has a reference on the non-woven fabric type polishing pad, which is disclosed in Japanese Patent Unexamined Application Publication No. 2-250776. The polishing pad is made by impregnating a non-woven fabric with polyurethane/DMF solution, and then, coagulating it in a DMF solution to form a polishing pad with micro pores. The polishing pad made as above has a problem of decreasing the degree of flatness of a semiconductor wafer since its surface is so soft which can easily cause due to compression, even though it has a good contact property with a semiconductor wafer and a good retention property for polishing slurry during the polishing process.

Further, a second example of the prior arts employs the foam polyurethane induced type polishing pad, which is disclosed in International Publication Number WO 9404599. The polishing pad is made by mixing and agitating isocyanate terminated urethane prepolymer and 4.4-methylene-bis-(2-chloroaniline) (MOCA) as a hardening agent (active hydrogen compound), adding and mixing a expanded organic polymer hollow sphere (brand name: Expancel 551 DE (Dry Expanded)) therein, hardening the mixture in a mold, and slicing the mold sheet hardened in the mold to a uniform thickness. Since the polishing pad made as above has a high surface hardness, it has an improved polishing speed and a flatness degree on the wafer, and it does not less distorted due to the compression as compared with the non-woven type. However, since the polishing pad uses an organic polymer hollow sphere, being prepared to be previously-expanded, and the expanded organic polymer hollow sphere has a low specific gravity of 0.042, its viscosity becomes increased when mixed with isocyanate terminated urethane prepolymer, and bubbles are generated when mixed with the hardening agent (MOCA) to make the bubbles remain inside the mold. As the specific gravity difference between the expanded organic polymer hollow sphere and the isocyanate terminated urethane prepolymer is great, the mixture (compound) of these substances is easily separated, and the discharged mixture may show large deviation in the mixing composition. In specific, when injecting the resin composite liquid made by mixing and agitating the compounds and the hardening agent into the mold, and the hollow sphere rises up and distributes non-uniformly in the upper portion of the mixture before the resin is hardened. Eventually, the polishing pad produced by slicing the mold in the plane direction, having a predetermined thickness, has density and hardness differences between the top portion and the bottom portion of the pad, and thus, material qualities of the pad are non-uniform, and deviation in the polishing characteristics happens among the production lots of the polishing pad. Further, there is another problem in that, since the organic polymer hollow sphere contains low boiling point hydrocarbon in its hollow portion, and its exterior portion is composed of thermoplastic resin of acrylonytrile-vinylidene chloride copolymer or acrylonytrile copolymer, the thermoplastic resin of the pores causes scratches on the wafer surface and thus the production yield is decreased.

As a third example of the prior arts to solve such problems, International Publication Number WO 0196434 discloses a method of forming pores by injecting a non-reactive gas into a pad composition without separately adding hollow sphere. In this regard, a first ingredient liquid is first obtained by mixing isocyanate terminated urethane prepolymer with silicone-based nonionic surfactant containing no hydroxyl group, and then, the first ingredient is agitated at high speed while the non-reactive gas is injected into it so as to make a cream-like bubble dispersion, and is allowed to pass through a sieve mesh in order to remove relatively big bubbles. Then, the cream-like bubble dispersion is injected into a bi-axial planet type mixer, and mixed with a hardening liquid as a second ingredient liquid to make a mixture, and then, the resultant mixture is agitated, molded, and sliced so as to fabricate polishing pads with micro pores.

However, the polishing pad fabricated as described above also has a problem in that non-uniform bubbles are generated during the process of preparing the cream-like bubble dispersion liquid, and the resulting distribution of bubble size and spacing is non-uniform. Furthermore, polishing speed and polishing efficiency are decreased, and the uniform process conditions are difficult to be controlled in the fabrication process since the polishing characteristics of the polishing pad vary depending on the locations and the production lots of a mold body. Thus, an additional sieving process, which is employed to remove relative big bubbles and to solve the above problems, makes the fabrication processes complicated, and eventually, just the sieving process alone cannot be expected to sufficiently provide the desired results.

Further, as described above, the cream-like bubble dispersion liquid is obtained while the non-reactive gas is injected into a specific first ingredient liquid before the second ingredient liquid is mixed. Once the cream-like bubble dispersion liquid is obtained, the process of mixing the second ingredient liquid should be rapidly performed in order to suppress the change of the properties of the composition. That is, since the retention property to maintain each ingredient in the mixture is poor and the maintenance life is short, the process margin of the fabrication process is decreased.

There exists a further problem in that the mixing of the cream-like bubble dispersion liquid with another first ingredient liquid makes it difficult to mix the mixture efficiently and easily, and as a result, the process conditions are strict and the total time for the fabrication process is increased. Moreover, the reliability of the CMP process is also degraded since the distribution of the pores in the mixture is not uniform, and the characteristics of the polishing pad vary depending on the locations and the production lots of the molded body.

Further, in the step of rapidly agitating the first ingredient liquid including a mixture of isocyanate terminated urethane prepolymer and silicone-based nonionic surfactant while injecting a non-reactive gas into it, in the case that the silicone-based nonionic surfactant includes hydroxyl group, the isocyanate terminated urethane prepolymer reacts with the hydroxyl group during the high-speed agitating process. Therefore, in order to prevent the change of the property of the isocyanate terminated urethane prepolymer, there is a limitation that silicone-based nonionic surfactant containing no hydroxyl group should be selectively used, which results in a serious limitation to select the compositions for the polishing pad to meet various property requirements. Furthermore, the silicone-based nonionic surfactant containing a hydroxyl group is more widely used, less expensive, so the above limitation in selecting the surfactant leads to higher fabrication expenses, and the process margin thereof is also deteriorated.

### DISCLOSURE OF INVENTION

To solve the above problems, an object of the present invention is to provide a method of fabricating a polyurethane foam for simplifying the fabrication processes and increasing a process margin without the generation of scratches and with greater flexibility in selecting the materials for the ingredients thereof.

Another object of the present invention is to provide a polishing pad having uniformly-sized pores and an uniform distribution of the pores, which will exhibit a high polishing efficiency and a small deviation in polishing characteristics is low among production lots.

A further object of the present invention is to provide a polishing pad having excellent properties of durability, mechanical characteristics, etc. and a method of fabricating the same, which is efficient in the improvement of the operation environment by reducing the TDI monomer amount of urethane prepolymer, as one ingredient of the composition, and which provides easily control over the process conditions due to the lengthened maintenance life of the ingredients, etc.

The present invention suppresses the generation of scratches by injecting a non-reactive gas into a foam composition without the addition of hollow sphere, to form pores in the foam by itself.

Further, the fabrication process according to the present invention is also characterized in that the formation process of bubbles is made during the mixing of two ingredient liquids, and the mixing of the two ingredient liquids is easily performed, so that the uniformity of the pore size and the distribution of the pores can be achieved which reduces the deviation in the polishing characteristics among production lots, and the maintenance life of each ingredient is increased to increase the process margin. Thus, the process is simplified, and the process expenses are reduced while the process reliability is improved.

Further, the range of the surfactants available for selection is expanded since the bubble formation process is not performed in each step of preparing the individual ingredient so as to allow various properties in the fabricated polishing pad, and the selective possibility of various ingredients is increased under various process conditions so as to increase the process margin and reduce the process expenses.

In accordance with the present invention, a method is provided of fabricating a polyurethane foam with micro pores and a polishing pad therefrom, in which the method may include the steps of (a) adding a nonionic surfactant into at least one of a first ingredient including an isocyanate group-containing compound and a second ingredient including an active hydrogen group-containing compound, (b) agitating and mixing the mixture of the first ingredient and the second ingredient while adding a non-reactive gas into it, (c) discharging the mixture out of a container at a predetermined rate, and (d) injecting the discharged mixture into a mold so as to form a mold body into a predetermined shape. If necessary, an organic hollow sphere or an inorganic hollow sphere can be added into the mixture of the two ingredient liquids in the step (b).

In more detail, the present invention provides a method of fabricating a polyurethane foam with micro pores, and a polishing pad therefrom, in which the method may include the steps of (a) adding 0.1 to 10 parts by weight of a silicon-based nonionic surfactant with respect to 100 parts by weight of the isocyanate terminated urethane prepolymer into at least one of a first ingredient including an isocyanate terminated urethane prepolymer and a second ingredient including an active hydrogen group-containing compound, (b) agitating the mixture of the first ingredient and the second ingredient under a pressure of 2 to 15 bar while injecting a non-reactive gas into it, and discharging the mixture at a rate of 2 to 20 kg/min to the outside, in which the non-reactive gas is injected at a rate of 0.1 to 1 L/min per kg of the discharged mixture, and (c) injecting the discharged mixture into a mold for molding.

### BRIEF DESCRIPTION OF THE DRAWINGS

FIG. 1 is a schematic view illustrating the processes of producing a polyurethane foam according to a second comparative example;

FIG. 2 is a schematic view illustrating the processes of producing a polyurethane foam according to a first embodiment of the present invention;

FIG. 3 is a SEM (scanning electron microscope) representation of a polishing pad fabricated according to a first embodiment of the present invention; and

FIG. 4 is a SEM representation of a polishing pad fabricated according to a second embodiment of the present invention.

### BEST MODE FOR CARRYING OUT THE INVENTION

Reference will now be made in detail to the preferred embodiments of the present invention, examples of which are illustrated in the accompanying drawings.

First, the conditions of the processes and the component ingredients will be described in detail.

1. Process Conditions

While the step (b) is performed, the mixed liquid is discharged at a predetermined rate, and injected into a mold in the step (c).

For the non-reactive gas in the step (b), an inert gas such as nitrogen, argon, neon, etc., oxygen, carbonic acid gas, or air can be used, and alternatively, isocyanate-containing compound, or any gas, if not reacts with active hydrogen, can also be used. However, nitrogen is most preferable in the aspects of cost and stability. The document WO 0196434, which is mentioned as a third prior art, discloses various non-reactive gases, and is incorporated herein and constitutes the present invention.

The amount of the non-reactive gas to be injected is based on the amount of the mixed liquid to be discharged out, and the amount is 0.1 to 1 L/min per kg of a discharged mixed liquid, and preferably, the amount is 0.3 to 0.7 L/min per kg. That is, in the case that the amount of a discharged mixed liquid is 3 kg/min, an appropriate amount of an injected gas is 0.3 to 3 L/min, and in the case that the amount of a discharged mixed liquid is 7 kg/min, it is appropriate to inject the gas at a rate of 0.7 to 7 L/min. If the amount of an injected gas is equal to or less than 0.1 L/min per kg of the amount of a discharged mixed liquid, pores are inadequately formed, and in the meantime, if the amount of an injected gas is equal to or more than 1.0 L/min per kg of the amount of a discharged mixed liquid, the size of the pore is so large that the hardness of the foam is decreased. Therefore, the polishing pad fabricated as above has a low hardness, and is so soft that a polishing efficiency and a flatness characteristics are deteriorated, which is not preferable, even though the contact characteristic and slurry retention characteristics become improved due to the softness. In case of fabricating a soft polishing pad requiring such physical properties as above, the amount of an injected non-reactive gas can be set to be 1 L/min or higher than that. The amount of an injected gas can be exactly controlled by using a mass flowmeter, etc. to fabricate a polishing pad having uniform micro pores.

Similarly, the amount of the discharged mixed liquid in the step (b) can be controlled appropriately depending on the physical properties required for a desired polishing pad, and normally, the amount is 2 to 20 kg/min, and preferably, 2 to 7 kg/min. In specific, if the discharged amount is equal to or less than 2 kg/min, the total time of the fabrication processes is increased and thus its productivity is deteriorated, while if it is equal to or more than 20 kg/min, the uniformity in the pore size and the spatial distribution of the pores are decreased.

Further, the step (b) is preferably performed with a predetermined pressure, and normally, the pressure is 2 to 15 bar, preferably, 4 to 10 bar and more preferably, about 5 bar. If the pressure is below 2 bar, or over 15 bar, the distribution of pore size and the spatial distribution is non-uniform.

In the step (b), the speed of agitating the mixture can be determined such that the second ingredient liquid and the non-reactive gas are properly mixed, and it is in a range of 3,000 to 10,000 rpm, preferably 3,000 to 6,000 rpm, and more preferably, about 5,000 rpm but not limited thereto, though. Those skilled in the art can select the speed appropriately in consideration of the composition, physical properties, and the amount of the second ingredient liquid, the size of an agitator, and the amount of the injected non-reactive gas.

As mentioned above, the non-reactive gas is formed in micro pores having about 5 to 150 μm in diameter which is made of an additive such as isocyanate terminated urethane prepolymer or active hydrogen compound and silicon based surfactant to be used by adjusting conditions such as the injecting amount, injecting pressure, agitating speed, discharging amount, and discharging pressure, the diameter of the micro pores are adjusted uniformly in the range of 20 to 80 μm by adjusting the above condition.

2. Surfactant

In the step (a), a surfactant can be added to either of the first ingredient or the second ingredient, or both thereof, but preferably to the first ingredient. Further, the total amount of addition is 0.1 to 10 parts by weight with respect to 100 parts by weight of the isocyanate group-containing compound, preferably, 0.5 to 5 parts by weight, and more preferably, 1 to 3 parts by weight. If the content of the surfactant is less than 0.1 parts by weight, it is difficult to generate bubbles. On the other hand, if the content of the surfactant is equal to or more than 10 parts by weight, bubbles are generated to the extend that increased viscosity make handling difficult, and mixing process conditions are strict. Furthermore, due to the formation of too many bubbles, the hardness of the polishing pad is decreased, and its flatness also becomes degraded.

The surfactant can employ a silicone-based nonionic surfactant, but also can employ various kinds of surfactants depending on the physical properties required for the polishing pad. The silicone-based nonionic surfactant can solely use a silicone-based nonionic surfactant containing a hydroxyl group alone, or can use along with a silicone-based nonionic surfactant containing no hydroxyl group.

The silicone-based nonionic surfactant containing a hydroxyl group is a kind of spermatophore agent which has good compatibility with isocyanate-containing compound and active hydrogen compounds, and is widely used in the polyurethane field. For the silicone-based nonionic surfactant containing a hydroxyl group being used in the present invention, known substances or commercially available substances can be employed. One of the commercially available substances is “DOW CORNING 193” (Silicone glycol copolymer: characteristic appearance=clear to hazy, liquid; specific gravity at 25□/15.6□=1.07; viscosity at 20□=465 mm²/s; flash point-closed cup=92□)(hereinafter, referred to as DC-193) produced by the Dow Corning Co., etc.

For the silicone-based nonionic surfactant containing no hydroxyl group, typically known substances or commercially available substances can also be used, and the various substances disclosed in the International Publication Number WO 0196434, referred to as the third prior art, can also be employed in the present invention. One of the commercially available silicone-based nonionic surfactant containing no hydroxyl group is “DOW CORNING 190” (Silicone glycol copolymer: DOW CORNING 190 Surfactant is referenced in JCIC under the chemical name Poly (oxyethylene oxypropylene), methyl polysiloxane copolymer with the code 521013 in the CLS categories: 1-11) (characteristic: Color(Gardner Scale)=2; Specific gravity at 25□/15.6□=1.037; Viscosity at 25□=2000 mm²/s; Flash point-closed cup =>63□; Inverse solubility point (1.0% water solution)=36□)(hereinafter referred to as DC-190), etc.

3. Isocyanate-Containing Compound

Various isocyanate-containing compounds, a method of fabricating the same, various starting substances being in use for the fabrication, and reactive substances are disclosed in the WO 0196434 referred to as the third prior art herein, and description thereof is incorporated herein and to constitutes the present invention.

Preferably, isocyanate terminated polyurethane prepolymer is used as the isocyanate-containing compound.

The isocyanate terminated polyurethane prepolymer can be obtained by reacting □ isocyanate, □ polyols, and □ extender. If the content of monomer of TDI (toluene diisocyanate) is set to 0.1% less than the content of TDI monomer of general urethane prepolymer, i.e., 0.2 to 0.5%, working environments can be improved and maintenance life can be extended so as to improve the process margin. As a result, the physical properties of the resultant polyurethane foam and the polishing pad fabricated by the method as above, such as a durability and mechanical characteristics, etc can be improved.

As a starting substance of the isocyanate terminated urethane prepolymer, □ isocyanate mainly uses 2.4-tolylene diisocyanate, but other kinds of diisocyanate may be used together therewith only if the effect of the present invention is not hindered. Examples include compound such as 2.6-toluene diissocyanate (TDI), 4.4-diphenyl methane diisocyanate (MDI), xylene diisocyanate (XDI), isophorone diisocyanate (IPDI), hydrogenated diphenylmethane diisocyanate (HMDI), etc, but are not limited thereto. □ For the polyols, polyether-based polyols such as poly(oxytetramethylene)glycol, poly(oxypropylene)glycol, etc, polycarbonate-based polyols, polyester-based polyols, etc may be used. □ For the extender, low molecular weight polyols, such as ethylene glycol, 1.2-propylene glycol, 1.3-propyleneglycol, 1.4-butanediol, neopentyneglycol, 1.5-pentanediol, 1.6-hexanediol, diethyleneglycol, etc may be used. Finally, while not being limited thereto, the starting substance of the isocyanate terminated urethane prepolymer includes various known substances and various substances disclosed in the WO 0196434 which is referred to as the third prior art.

4. Active Hydrogen Compound

The active hydrogen compound functions as a crosslink agent of isocyanate terminated urethane prepolymer to harden a mixture, and may use a solid state of polyamine (MOCA) at a room temperature solely, or a mixture of a solid state of polyamine and a liquid state of polyols. For example, there are amines such as 3.3-dichloro 4.4-diamino diphenylmethane, chloroaniline denaturation-chlorodiaminophenylmethane, 3.5-bis(methylthio)2.4-toluene diamin, 3.5-(methylthio)2.6-toluenediamin, amino ethyl piperazine, meta xylene diamin, etc, and at least one of them is generally used. Such diamines can be used alone, but if necessary, polyether polyols such as poly(oxytetramethylene)glycol, poly(oxypropylene) glycol, etc, polycarbonate polyols, polyester polyols, etc can be used together with that. The molecular weight of polyols to be used jointly with the amine, is preferably low, and more preferably, poly(oxytetramethylene)glycol, polycarbonate glycol of 500 to 3,000 in molecular weight can be selected. In addition, various substances disclosed in the WO 0196434, which is referred to as the third prior art herein, and other known substances can be used.

5. Organic Hollow Sphere and Inorganic Hollow Sphere

Organic hollow sphere or inorganic hollow sphere, if necessary, can be added to the mixture of the two ingredient liquids of the step (b).

The organic hollow sphere has hollow spheres formed inside an organic film, which is described in detail in the WO 9404599, herein referred to as the second prior art, and thus, the description thereof is incorporated herein and constitutes the present invention.

The inorganic hollow sphere is configured such that hydrocarbon having a low boiling point is formed on its inner shell, which is formed of thermoplastic resin of acrylonytrile-vinylidene chloride copolymer or acrylonytrile copolymer. On the surface of the inner shell, a film coating of inorganic powder particles, such as titanium oxide, calcium carbonate, silica, cerium oxide, or ceramic is deposited by a coating method, etc. The diameter of the particles may be in the range of 20 to 50 μm for small ones, and in the range of 80 to 150 μm for large ones, which are used alone or in a mixture thereof. Its specific gravity is preferably in a range of 0.1 to 0.4±0.05 g/cm³. As described above, even with the addition of a small amount of the inorganic hollow sphere into the mixture, its polishing efficiency is improved, and polishing can be possible without the application of an additional polishing agent, as well as the advantage in the reduction of production expenses.

6. Temperature Condition in the Mixing of Two Ingredient Liquids

Before mixing the two ingredient liquids, i.e., in the step of injecting the first and the second ingredient liquids into a two ingredients molding machine for molding two ingredient liquids, the temperature of isocyanate terminated urethane prepolymer or active hydrogen compound is maintained within a range not to affect the operation of the two ingredients molding machine.

In specific, the isocyanate terminated prepolymer is preferably maintained at a temperature of 60 to 110□, and particularly, at 70 to 90□. An active hydrogen compound, for instance, is maintained at a temperature of 100 to 120□ in the case that diamines are 3.3-dichloro 4.4-diaminophenylmethane in a solid state at a room temperature, or is preferably maintained at the temperature of 60 to 100□ in the case of diamines in liquid state at a room temperature and a mixture of diamines and polyols.

7. Physical Properties of a Polishing Pad

In a polishing pad with micro pores fabricated by the present invention, the non-reactive gases are dispersed uniformly with a volume ratio in a predetermined range in a matrix consisting of an additive such as an isocyanate terminated urethane prepolymer or active hydrogen compound and silicon based surfactant to be used. The micro pores included in the polishing pad fabricated as mentioned above is about 20 to 150 μm in size, those having 50 to 80 μm in size is in the proportion of 70 to 80 μm/% to the whole micro pore size. Therefore, density of the polishing pad having micro pores is in the range of 0.5 to 1.0 g/cm³ compared with 1.2±0.05 g/cm³ which is the density of polishing pad without micro pores. If calculated in terms of percentage, the proportion of volume of the micro pores with respect to the matrix in the unit volume is in the range of 17 to 59%. More preferably, the density of the micro pores is 0.7 to 0.9 g/cm³, that is, the proportion of volume of the micro pores with respect to the matrix is in the range of 25 to 42% in the unit volume. Further, as mentioned above, the micro pores included in the polishing pad cause degradation of hardness of the polishing pad. But, hardness of the polishing pad having micro pores may vary depending to the kinds and the amount of isocyanate terminated urethane prepolymer or active hydrogen compound and silicone-based surfactant, etc. Typically, the hardness is in the range of shore D=50 to 70, and preferably, shore D=56 to 68. The hardness is an important consideration in the aspect of polishing efficiency during the polishing process, surface quality, and flatness attained during the processing process. The pad having a high hardness helps to improve the polishing efficiency, but the surface quality and the flatness are decreased. On the contrary, in the case of a pad having a low hardness, surface quality and flatness are increased, while polishing efficiency is decreased. Therefore, as described above, the polishing pad having micro pores has enough hardness to improve the polishing efficiency. In order to improve the surface quality and flatness for the wafer, a combined pad prepared by a stack of a non-woven fabric or a high polymeric foam formed on an underlying polishing pad having a high hardness, in which the non-woven fabric or the high polymeric foam act to support the upper pad and buffer is used. As the non-woven fabric or the high polymeric foam is suitable with a compression rate of 5 to 15%, a compression elasticity rate of 55 to 75%, and hardness of 60 to 78 shore A.

As described above, the polishing efficiency and a flatness degree are dependant on the characteristics of the polishing pad, and also, can be affected by the surface shape of the pad, etc. In order to make the slurry supplied on the top surface of the polishing pad flow and distribute uniformly during the polishing process, and contributes to prevent the slurry from spilling out of the polishing region, and allows the slurry to be distributed uniformly all over the surface of the pad, the pad have a surface with X-Y shape (cross shape) or a rectangular-shape macro groove, and a micro groove, which is formed between the above macro grooves or solely formed, having the width and depth smaller than those of the first macro groove. For example, the macro groove is 0.3 to 1.5 mm in depth, 0.1 to 1.0 mm in width, and 1.0 to 8.0 mm in a length, and the micro groove is 0.2 to 1.0 mm in depth, 0.1 to 0.5 mm in width, and 1.0 to 5.0 mm in a length.

Hereinafter, polyurethane foam is fabricated according to a preferred embodiment of the present invention and comparative examples (Table 1), and the measurement results of the polishing characteristics of the polishing pad, fabricated as above, can be evaluated using a method as follows (see Table 2).

<Evaluation Method of Polishing Characteristics>

1. Polishing Speed

A polishing test is made for 1 minute, and before and after the test, the thickness of a subject to be polished is measured respectively. Forty nine locations will be selected in advance on the surface of the subject as positions for measurement. The difference values of the thicknesses of the subject in the 49 locations before and after the test are averaged, and the average value is assumed a polishing speed of one piece of a polishing pad.

The average value A and the variance B of the polishing speeds of ten pieces of polishing pads having identical micro pores are marked as A±B to evaluate polishing characteristics and deviation among production lots. A is related to polishing characteristics, and the higher the value A is, the better the polishing efficiency is. B is related to deviation among production lots, and the lower the value B is, the more the stable polishing characteristics are.

2. Flatness

A polishing test is made for 1 minute. The thickness of the subject to be polished is measured before and after the test respectively. Forty nine locations for measurement are selected on the surface of the subject in advance. A flatness of one piece of a polishing pad can be calculated using the equation as follows from the maximum (Max) and the minimum (Min) of the difference of the thicknesses in the forty nine locations, which are measured before and after the test, and the average of the values.
Flatness=100×(Max−Min)/Average

The average C of the flatness values of 10 pieces of polishing pads having identical micro pores, and the variance D thereof are marked as C±D to evaluate the polishing characteristics of the polishing pads, and the deviation among production lots. C is related to the polishing characteristics, and a lower value of C represents a higher flatness of the surface to be polished. D is related to the deviation among production lots, and a lower value of B represents the more stable polishing characteristics.

### EMBODIMENTS AND COMPARATIVE EXAMPLES

### Comparative Example 1

A mixture, which is made by mixing 2.3 parts by weight of expanded hollow sphere (brand name: Expancel-551 DE) with 100 parts by weight of isocyanate terminated urethane prepolymer (brand name: Adiprene L-325, TDI/PTMG/DEG-based, NCO content of 9.0 to 9.3%), is heated at a temperature of 70□. Twenty five parts by weight of active hydrogen compound MOCA is heated at a temperature of 120□. The mixture, in which these two ingredient liquids are mixed, is injected into a mold of which the temperature is 100□, and then, the mold is heated in an oven at a temperature of 110□ for 30 minutes to be cured firstly the mixture. After demolding, a casting is cured at a temperature of 120□ for 5 hours, and then, is cooled down to 25□. Then, the casting is sliced to the thickness of 1.3 mm in order to fabricate polishing pads. Grooves are formed in the surface of the sliced polishing pad so as to increase polishing efficiency by effectively controlling the amount of slurry injected between the pad surface to be used for polishing wafer and a wafer. A plurality of macro grooves having an X-Y shape are formed on the surface of the polishing pad in parallel with each other about X-Y axes, and at the same time, micro grooves having different widths, depths, and pitches are formed. A non-woven fabric with the thickness of 1.25±0.03 mm, the compression of 10±1%, and the hardness of 70±2 shore A is bonded to the underlying polishing pad having the grooves formed as above so as to fabricate a laminated-type polishing pad.

Then, ten samples of polishing pads fabricated by the method as described above are mounted into a polishing apparatus, and the polishing characteristics of a SiO₂ layer is measured. A polishing test is carried out under conditions in which the amount of injected slurry is 150 ml/min, the weight of a wafer is 5.5 psi, the rotating number of a turntable is 30 rpm, the rotating number of a head is 30 rpm, and the polishing time is 60 sec. As a result, the polishing speed is 3000±200/min, and the flatness is 5±1%.

### Comparative Example 2

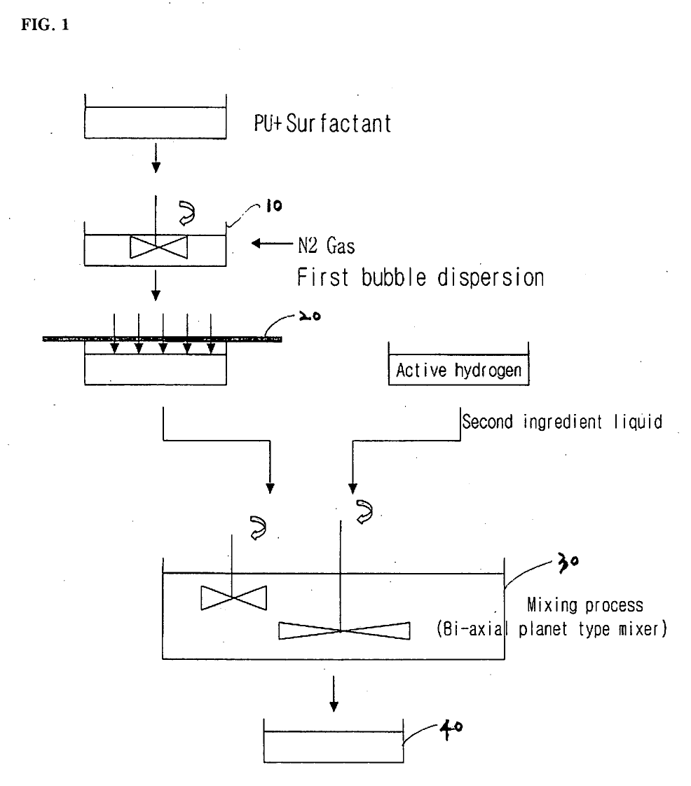

As shown in a schematic view of FIG. 1, 1 part by weight of silicone-based nonionic surfactant containing no hydroxyl group (brand name: SH-190) is mixed with 100 parts by weight of isocyanate terminated urethane prepolymer Adiprene L-325, and then, the mixture is rapidly agitated at a speed of about 3500 rpm for 1 minute 30 seconds while a non-reactive gas N₂ is injected into a mixer 10. As a result, a cream-like bubble dispersion is obtained. The above bubble dispersion is passed through a sieve mesh 20 to remove non-uniform bubbles, and is transferred to a planet-shaped mixer 30. Then, 26.2 parts by weight of methylene bis-o-chloroaniline [MBCA, IHARA CHEMICAL INDUSTRY Co., Ltd.] which is dissolved at a temperature of 120□, is mixed therewith, and the mixture is injected into a mold 40, and then, is cured at a temperature of 80 to 90□ for about 12 hours. The casting is cooled down to 25□, and then, is sliced to the thickness of 1.3 mm to fabricate polishing pads. Grooves are formed in the underlying pad in the same way as the comparative example 1 so as to fabricate a laminated pad. As a result of performing a test under the same polishing conditions as the comparative example 1, the polishing rate is 2800±200/min, and the flatness is 3±1%.

### Embodiment 1

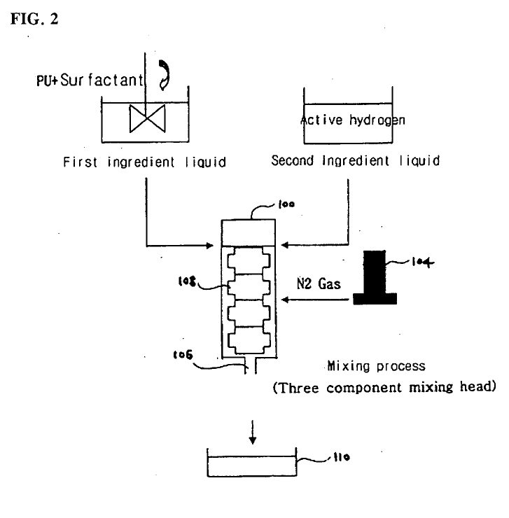

As shown in the schematic view of FIG. 2, 1 part by weight of silicone-based surfactant containing a hydroxyl group (brand name: DC-193, DOW CORNING Co., Ltd.) is mixed with 100 parts by weight of isocyanate terminated urethane prepolymer Adiprene L-325, and then, is reacted with each other at a temperature of 60□ for 2 hours. As a result, the hydroxyl group of the silicone-based surfactant becomes extinct and uniform and stabilized urethane prepolymer reaction liquid (a first ingredient liquid) is obtained. The first ingredient liquid is transferred to an air nucleation type molding machine 100, and then, non-reactive gas N₂ is injected into it using a mass flowmeter 104 while injecting 24 parts by weight of MBCA (with respect to 100 parts by weight of isocyanate terminated urethane prepolymer Adiprene L-325) dissolved at a temperature of 120□ therein as a second ingredient liquid. Subsequently, the mixture is mixed and agitated by revolving paddles 108 and discharged through an outlet 106 at a predetermined rate. As shown in the schematic view of FIG. 2, in order to facilitate easy mixing and generate uniform bubble, the revolving paddles 108 preferably are of tub types and have a narrow clearance between the revolving paddles and the inner surface of the molding machine 100 narrow. As process conditions for the molding machine 100, a pressure is set to be 5 bar, the discharge amount is set to be 3 kg/min, and the injection speed of the non-reactive gas is set to be 1 l/min (20% of control level of the mass flowmeter), and the rotation speed of the revolving paddles is set to be 5,000 rpm.

The discharged mixture to the outside is directly injected into a mold 110 and passes through a molding process. The mixture of the two ingredient liquids is injected into the mold, and cured at a temperature of 80 to 90□ for about 12 hours. The casting is cooled down to 25□, and then, in the same way as the comparative example 1, is sliced and passed through a groove formation process so as to come out as a laminated-type polishing pad.

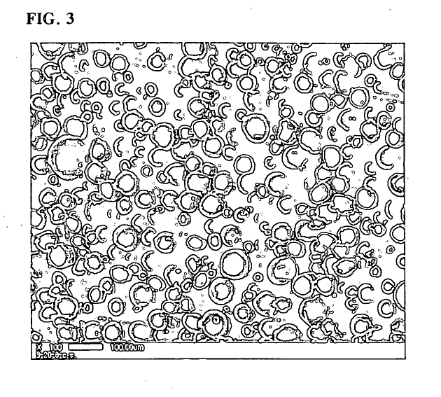

In a test under the same polishing condition as the comparative example 1, a polishing speed is 2900±200/min, and a flatness is 5±1%. The surface of the polishing pad is examined using a scanning electron microscope to observe a shape of the cell and the fineness thereof, and then, the observation result is recorded in the Table 2. As shown in FIG. 3, it is found that uniform and fine micro pores are formed. (see FIG. 3)

### Embodiments 2 to 9

A polishing pad is fabricated by the same method as the comparative example 1, by changing the content of the surfactant, the amount of the discharged mixture, and the amount of the injected non-reactive gas, etc. with the composition ratios as shown in following Table 1, and the polishing characteristics of the polishing pad are evaluated. The results of the evaluation are shown in Table 2. As a result of examining the polishing pad produced by the embodiment 2 by using a SEM, the pores formed thereon are found to be very uniform and fine.

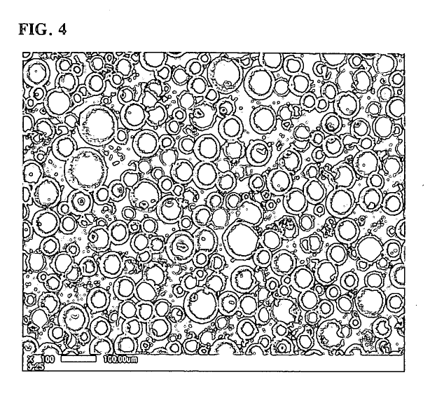

(see FIG. 4)

TABLE 1
Composition amounts and process conditions for fabricating a polishing pad

| | | | | | Control level | | |
|---|---|---|---|---|---|---|---|
| | | | | Active | of mass | | |
| | Urethane | Hollow | | hydrogen | flowmeter | Discharge | |
| | prepolymer | sphere | Surfactant | compound | <injecton of | of mixture | Agitating |
| | (parts by | (parts by | (parts by | (parts by | non-reactive | solution | speed |
| | weight) | weight) | weight) | weight) | gas> (l/min) | (kg/min) | (rpm) |
| Comparative | L-325 100 | Expancel | — | MOCA 25 | — | — | — |
| example 1 | | 2.3 | | | | | |
| Comparative | L-325 100 | — | DC-190, 1.0 | MBCA 26.2 | — | — | 3,500 |
| example 2 | | | | | | | |
| Embodiment 1 | L-325 100 | — | DC-193, 1.0 | MBCA 24 | 20% (1 l/min) | 3 | 5,000 |
| Embodiment 2 | L-325 100 | — | DC-193, 2.0 | MBCA 24 | 20% (1 l/min) | 3 | 3,500 |
| | | | DC-190, 1.0 | | | | |
| Embodiment 3 | L-325 100 | — | DC-193, 3.0 | MBCA 24 | 25% (1.25 l/min) | 3 | 5,000 |
| Embodiment 4 | L-325 100 | — | DC-193, 3.0 | MBCA 24 | 30% (1.5 l/min) | 3 | 5,000 |
| Embodiment 5 | L-325 100 | — | DC-193, 3.0 | MBCA 24 | 40% (2 l/min) | 5 | 5,000 |
| Embodiment 6 | L-325 100 | — | DC-193, 3.0 | MBCA 24 | 40% (2 l/min) | 5 | 5,000 |
| Embodiment 7 | L-325 100 | — | DC-193, 3.0 | MBCA 24 | 50% (2.5 l/min) | 7 | 5,000 |
| Embodiment 8 | L-325 100 | — | DC-193, 2.0 | MBCA 24 | 40% (2 l/min) | 5 | 5,000 |
| | | | DC-190, 1.0 | | | | |
| Embodiment 9 | L-325 100 | — | DC-193, 2.5 | MBCA 24 | 0% (2 l/min) | 5 | 5,000 |
| | | | DC-190, 0.5 | | | | |
| Embodiment 10 | L-325 100 | 80GCA | DC-193, 3.0 | MBCA 24 | 40% (2 l/min) | 5 | 5,000 |
| | | 0.5 | | | | | |

TABLE 2
Physical property and polishing characteristics of a polishing pad

| | Comparative | Comparative | Embodiment | Embodiment | Embodiment | Embodiment |
|---|---|---|---|---|---|---|
| | example 1 | example 2 | 1 | 2 | 3 | 4 |
| Polishing | 3,000 ± 200 | 2,800 ± 200 | 2,900 ± 200 | 3,000 ± 200 | 3,400 ± 200 | 3,200 ± 200 |
| speed | | | | | | |
| Flatness | 5 ± 1 | 3 ± 1 | 5 ± 1 | 4 ± 1 | 3 ± 1 | 3 ± 1 |
| Hardness | 57 | 58 | 68 | 68 | 60 | 57 |
| (shore D) | | | | | | |
| Cell | ∘ | ∘ | ∘ | ∘ | □ | □ |
| shape, | | | | | | |
| fineness | | | | | | |
| | Embodiment | Embodiment | Embodiment | Embodiment | Embodiment | Embodiment |
| | 5 | 6 | 7 | 8 | 9 | 10 |
| Polishing | 3,400 ± 100 | 3,500 ± 100 | 3,200 ± 200 | 3,400 ± 200 | 3,300 ± 100 | 3,400 ± 200 |
| speed | | | | | | |
| Flatness | 3 ± 1 | 3 ± 1 | 4 ± 1 | 3 ± 1 | 3 ± 1 | 3 ± 1 |
| Hardness | 62 | 63 | 61 | 62 | 61 | 62 |
| (shore D) | | | | | | |
| Cell | □ | □ | ∘ | □ | □ | □ |
| shape, | | | | | | |
| fineness | | | | | | |

∘: Good
□: Excellent

As confirmed in Tables 1 and 2, the polishing pad, which is fabricated in consideration of the appropriate control of the content of a silicone-based nonionic surfactant, the injection amount of a non-reactive gas, and an amount of mixing/discharge or the like according to the present invention, has excellent polishing efficiency and flatness, and shows stable polishing characteristics.

### INDUSTRIAL APPLICABILITY

As described above, the present invention provides an advantage of suppressing the generation of scratches on the foam fabricated therefrom, since the foam of the present invention is configured to have the pores formed inside the foam through the process of injecting a non-reactive gas into the foam composite, unlike other cases requiring to involve the insertion of spheres into the foam composite. Specifically, bubbles are arranged to be formed during the mixing process of two ingredients, so as to facilitate the generation of the pores in the foam with uniform size and spatial distribution. Additionally, the whole processes are simplified and the process margin is increased, thereby to reducing the fabrication expenses and increasing the process reliability with an improved productivity.

1. A method of fabricating a polyurethane foam with micro pores comprising the steps of:
(a) adding a nonionic surfactant into at least one of a first ingredient including an isocyanate group-containing compound and a second ingredient including an active hydrogen group-containing compound;
(b) agitating and mixing the mixture of the first ingredient and the second ingredient while adding a non-reactive gas thereto;
(c) discharging the mixture out of a container at a predetermined rate; and
(d) injecting the discharged mixture into a mold so as to form into a predetermined shape.

2. The method according to claim 1, wherein the steps (b) and (c) are carried out simultaneously.

3. The method according to claim 1, wherein, in the step (b), the non-reactive gas is injected at a rate of 0.1 to 1 L/min per kg of the discharged mixture.

4. The method according to claim 3, wherein, in the step (b), the non-reactive gas is injected by a rate of 0.3 to 0.7 L/min per 100 kg of the discharged mixture.

5. The method according to claim 1, wherein, in the step (c), the amount of the discharged mixture is 2 to 20 kg/min.

6. The method according to claim 5, wherein, in the step (c), the amount of the discharged mixture is 2 to 7 kg/min.

7. The method according to claim 3, wherein the step (b) is carried out under a pressure of 2 to 15 bar.

8. The method according to claim 7, wherein the step (b) is carried out under a pressure of 4 to 10 bar.

9. The method according to claim 1, wherein the amount of the added surfactant is 0.1 to 10 parts by weight with respect to 100 parts by weight of the isocyanate group-containing compound.

10. The method according to claim 9, wherein the content of the surfactant in the mixture in the step (b) is 1 to 3 parts by weight with respect to 100 parts by weight of the isocyanate group-containing compound.

11. The method according to claim 1, wherein the content of the active hydrogen group-containing compound in the mixture in the step (b) is 15 to 50 parts by weight with respect to 100 parts by weight of the isocyanate group-containing compound.

12. The method according to claim 1, wherein the isocyanate group-containing compound is an isocyanate terminated urethane prepolymer.

13. The method according to claim 9, wherein the nonionic surfactant is a silicone-based nonionic surfactant containing a hydroxyl group, a silicone-based nonionic surfactant containing no hydroxyl group, or a mixture thereof.

14. The method according to claim 1, wherein the mixture in the step (b) further comprises an organic hollow sphere or an inorganic hollow sphere.

15. A method of fabricating a polyurethane foam with micro pores comprising the steps of:
(a) adding 0.1 to 10 parts by weight of a silicon-based nonionic surfactant with respect to 100 parts by weight of the isocyanate terminated urethane prepolymer into at least one of a first ingredient including an isocyanate terminated urethane prepolymer and a second ingredient including an active hydrogen group-containing compound;
(b) mixing and agitating the first ingredient and the second ingredient under a pressure of 2 to 15 bar while injecting a non-reactive gas thereinto, and discharging the mixture by a rate of 2 to 20 kg/min to the outside, in which the non-reactive gas is injected by a rate of 0.1 to 1 L/min per kg of the discharged mixture; and
(c) injecting the discharged mixture into a mold for molding.

16. The method according to claim 15, wherein, in the step (b), the non-reactive gas is injected by a rate of 0.3 to 0.7 L/min per kg of the mixture of the first ingredient and the second ingredient, and the pressure is 4 to 10 bar; and
in the step (c), the amount of the discharged mixture is 2 to 7 kg/min.

17. The method according to claim 15, wherein, in the step (a), the silicone-based nonionic surfactant is a silicone-based nonionic surfactant containing a hydroxyl group, a silicone-based nonionic surfactant containing no hydroxyl group, or a mixture thereof.

18. A polishing pad fabricated by using a method as claimed in claim 1.

19. The polishing pad according to claim 18, wherein the polishing pad has density of 0.5 to 1.0 g/cm3 and hardness of shore D of 50 to 70.

20. A polishing pad fabricated by using a method as claimed in claim 15.

21. A polishing pad fabricated by using a method as claimed in claim 16.

22. A polishing pad for planarizing a substrate surface, comprising a matrix having micro pores formed by non-reactive gases dispersed in an additive such as an isocyanate terminated urethane prepolymer or active hydrogen compound and silicon based surfactant,
wherein the micro pores form a continuous surface of the matrix by being exposed in the order approaching the surface in accordance with the polishing degree of the surface of the matrix, and
the proportion of volume of the micro pores with respect to the matrix is in the range of 17 to 59% in the unit volume.

23. A polishing pad as claimed in claim 22, the micro pores included in the matrix is about 20 to 150 μm in size.

24. A polishing pad as claimed in claim 22, the micro pores included in the matrix is about 50 to 80 μm in size.

25. A polishing pad as claimed in claim 22, the proportion of volume of the micro pores with respect to the matrix is in the range of 25 to 42% in the unit volume.
